(19) United States
(12) Patent Application Publication
(10) Pub. No.: US 2006/0122028 A1
(43) Pub. Date: Jun. 8, 2006

(54) Continuously variable transmission

(76) Inventors: Steffen Henzler, Bobingen (DE); Dinh Cuong Nguyen, Esslingen (DE)

Correspondence Address: KLAUS J. BACH, 4407 TWIN OAKS DRIVE, MURRYSVILLE, PA, 15668, US

(21) Appl. No.: 11/284,443

(22) Filed: Nov. 21, 2005

Related U.S. Application Data
(63) Continuation-in-part of application No. PCT/EP04/03391, filed on Mar. 31, 2004.

(30) Foreign Application Priority Data
May 22, 2003 (DE) 103 23 073.4

(51) Int. Cl. F16H 15/38

(52) U.S. Cl. 476/40

(57) ABSTRACT

In a continuously variable transmission with a toroidal variator including an input shaft supporting spaced outer toroidal disks, a hollow transmission shaft through which the input shaft extends and which supports inner toroidal disks between the outer toroidal disks axially spaced from the inner toroidal disks so as to form chambers therebetween, the hollow transmission shaft is supported via bearing supports which radially extend into at least one chamber of the toroidal variator and form bearing points resulting in a shortened axial overall length of the transmission as compared with transmissions having conventional bearing arrangements and also in an improved support structure.

This is a Continuation-In-Part Application of International Application PCT/EP2004/003391 filed May 22, 2004 and claiming the priority of German application 103 23 073.4 filed May 22, 2005.

### BACKGROUND OF THE INVENTION

The invention relates to a continuously variable transmission with a variator, that is a toroidal traction roller transmission having two chambers with traction discs disposed therein, for the transmission of power from input toric discs to an output toric disc at a variable transmission ratio.

The publication EP 1 186 798 A2 discloses a continuously variable transmission with a variator which has two chambers. A transfer of a drive torque from two inner toroidal discs (drive-connected to one another) to outer toroidal disks (likewise drive-connected) via rollers takes place in the variator. The continuously variable transmission has a transmission shaft which is mounted in an end region and which passes through the variator internally. The transmission has two bearing supports which are fixed with respect to the housing and which each extend radially through a respective chamber of the variator. The bearing supports, in this instance, serve for supporting the inner toroidal disks, so as to avoid tilting the inner toroidal disks due to the torque acting on them. In addition to the bearing supports being supported with respect to the housing, they are mounted on the radially internal transmission shaft and are supplied with lubricants by the latter. In addition to the above-mentioned mounting, the inner toroidal discs are mounted with respect to the internal transmission shaft via two further radially internal bearing units, the bearing units being exposed to high relative rotational speeds because of mutually opposite direction of rotation of the transmission shaft and of the inner toroidal disks.

A further continuously variable transmission is known from the publication DE 199 48 756 A1. According to the arrangement disclosed therein, inner toroidal discs are supported with respect to the transmission housing via a support frame, which is arranged so as to be disposed axially between the inner toroidal discs. This results in a relatively large radial and axial size of the variator and consequently of the continuously variable transmission.

Another embodiment of a continuously variable transmission with a support of an inner transmission shaft within a variator with respect to a transmission case is known from “Traction Drives: Selection and Application”, Frederick W. Heilich, Eugene E. Shube, ISBN: 0-8247-7018-8, cf. p. 94.

It is the object of the present invention to provide a continuously variable transmission with a support structure for a transmission shaft disposed in a variator with a relatively smaller space requirement.

### SUMMARY OF THE INVENTION

In a continuously variable transmission with a toroidal variator including an input shaft supporting spaced outer toroidal disks, a hollow transmission shaft through which the input shaft extends and which supports inner toroidal disks between the outer toroidal disks axially spaced from the inner toroidal disks so as to form chambers therebetween, the hollow transmission shaft is supported via bearing supports which radially extend into at least one chamber of the toroidal variator and form bearing points resulting in a shortened axial overall length of the transmission as compared with transmissions having conventional bearing arrangements and also in an improved support structure.

Accordingly, a support of the transmission shaft with respect to the housing of the transmission takes place solely via a first bearing support fixed with respect to the housing and a second bearing support fixed with respect to the housing. The first bearing support structure fixed with respect to the housing passes through the variator in the region of a first chamber in the radial direction. A first bearing unit acts between the first bearing support and the transmission shaft. The second bearing support fixed with respect to the housing passes through the variator in the region of a second chamber in the radial direction. A second bearing unit acts between the second bearing support and the transmission shaft.

It was recognized, according to the invention, that a mounting of the transmission shaft with respect to the housing which goes beyond the bearing supports may be omitted. Mounting with respect to the housing therefore takes place solely in an axial construction space which is required in any case for the variator. This avoids the need for axial construction space in order to ensure a mounting of the transmission shaft outside the variator with respect to the housing. The distance between the toroidal disks co-operating with one another is predetermined by the roller arranged therebetween. This results here, offset in the circumferential direction with respect to the rollers, in an axial construction space into which a bearing support can project from a housing. The configuration according to the invention accordingly affords an axially particularly compact axial type of construction.

In this instance, the outcome according to the invention can be achieved, in particular, for any transmission shaft which is designed as a solid shaft or as a hollow shaft and which projects from the variator on one side or on both sides or else is arranged completely within the variator. The shortened design of the transmission shaft makes it possible to have shortened lever arms of the forces acting on the transmission shaft, thus resulting in a lower bearing load. The bearing unit or bearing units involves or involve a radially and/or axially acting bearing of any desired type of construction. A bearing support or the bearing supports may emanate from one fastening location of the case or else project inward from a plurality of fastening locations (in a star-shaped manner) and merge into a common bearing ring, the bearing support or bearing supports being produced in one piece or in a plurality of pieces with the transmission housing.

In a particular embodiment of the abovementioned continuously variable transmission, the first bearing unit is designed as a fixed bearing, while the second bearing unit is designed as a loose bearing. This results in a mechanically defined mounting in terms of the degrees of freedom, so that further bearing points with respect to the case and/or to further transmission elements are not required. Of course, for further support, particularly where a large axial type of construction is concerned, further bearing points of the transmission shaft with respect to further transmission elements, for example radially internally or externally, may be provided by the transmission shaft. Alternatively, it is likewise conceivable that a support of the transmission shaft with respect to the housing takes place solely via loose bearings. In this instance, the transmission shaft is designed to be axially displaceable, for example to ensure a pressure force between the roller and toroidal disks, or a fixed bearing for the transmission shaft is provided between the transmission shaft and an adjacent transmission element.

In an alternative embodiment of the transmission according to the invention, the transmission shaft is supported with respect to the bearing supports by means of a first bearing unit acting axially on one side and a second bearing unit acting axially on the other side. In this instance, these bearing units may be assigned to a single bearing support or else to different bearing supports. The bearing units are in this instance arranged in an X-arrangement or in an O-arrangement. A good axial support of the transmission shaft with respect to the transmission case can thereby take place at relatively low cost.

The object the invention is further achieved by an arrangement wherein the transmission shaft is supported with respect to the housing solely via a single bearing support which is fixed with respect to the housing and which extends through the variator in the region of a chamber in the radial direction. Between the bearing support and the transmission shaft is arranged a fixed bearing which, on the one hand, has a needle bearing for accommodating radial forces. Needle bearings are distinguished by a small radial construction, along with high transmittable radial forces. On the other hand, the fixed bearing structure has at least one axial bearing (acting on one side or on both sides) for accommodating axial forces. Axial bearing units of this type, too, can be used at relatively low cost, with a small axial and radial overall size and with high transmittable axial forces. Furthermore, an improved mounting possibility is afforded if a needle bearing is used for radial support, so that, with the needle bearing mounted, it is still possible to have an axial displacement of the transmission shaft which is fixed only when the axial bearings are mounted. Furthermore, the incorporation of features mentioned with regard to the first embodiment of the invention is likewise possible.

The object is also achieved by a third embodiment of the invention, wherein the transmission shaft is supported with respect to the housing solely via a single bearing support which is fixed with respect to the housing. The bearing support extends through the variator in the region of a chamber in the radial direction. A loose bearing which has a needle bearing is arranged between the bearing support and the transmission shaft. An embodiment of this type is appropriate particularly when a floating mounting of the transmission shaft (along with a short axial length and low tilting moments) is desired. Alternatively, it is possible to have an embodiment for which, in addition to the loose bearing mentioned, a fixed bearing and/or loose bearing are/is provided between the transmission shaft and an adjacent transmission element which, in particular, is movable with respect to the housing. For the loose bearing to be designed according to the invention as a needle bearing constitutes a bearing possibility which is cost-effective, but which may be subjected to radially high stresses. Furthermore, the incorporation of features mentioned with regard to the first embodiment or to the second embodiment of the invention is likewise possible.

In a preferred embodiment of the continuously variable transmission, in addition to the support of the transmission shaft via the at least one bearing support, a bearing unit is provided between the transmission shaft and a further rotating transmission element. In this instance, for example for a coaxial arrangement of the transmission shaft and of the transmission element, the transmission shaft or the transmission element is arranged, with the bearing unit interposed, in an axial recess of the transmission element or of the transmission shaft respectively. This results in an especially compact construction.

In a further embodiment of the continuously variable transmission, the bearing unit in the form of a fixed bearing is designed as a four-point bearing. Such four-point bearings are compact bearing units which can reliably accommodate both axial and radial forces.

In a preferred embodiment of the continuously variable transmission, one end region of the transmission shaft is arranged within the variator, while the opposite end region of the transmission shaft projects from the variator for the transfer of a torque acting upon the variator and which, in particular, is an input torque or output torque of the variator or of the toroidal disks. Since the transmission shaft projects from the variator on only one side, the overall mass for the transmission shaft can be reduced and an additional bearing point with respect to the housing can be avoided. Other transmission elements may then be arranged in the available construction space.

Preferred exemplary embodiments of the continuously variable transmission according to the invention will be described in more detail below with reference to the accompanying drawings:

### BRIEF DESCRIPTION OF THE DRAWINGS

FIG. 1 is an exemplary axial cross-sectional view of a continuously variable transmission for a motor vehicle,

FIG. 2 shows in a cross-sectional view a detail II of the transmission diagram from FIG. 1,

FIG. 3 shows a first mounting arrangement of a transmission shaft in a variator,

FIG. 4 shows a second mounting arrangement of a transmission shaft in a variator,

FIG. 5 shows a third mounting arrangement of a transmission shaft in a variator,

FIG. 6 shows a fourth mounting arrangement of a transmission shaft in a variator,

FIG. 7 shows a fifth mounting arrangement of a transmission shaft in a variator, and

FIG. 8 shows a sixth mounting arrangement of a transmission shaft in a variator.

### DETAILED DESCRIPTION OF THE PARTICULAR EMBODIMENTS

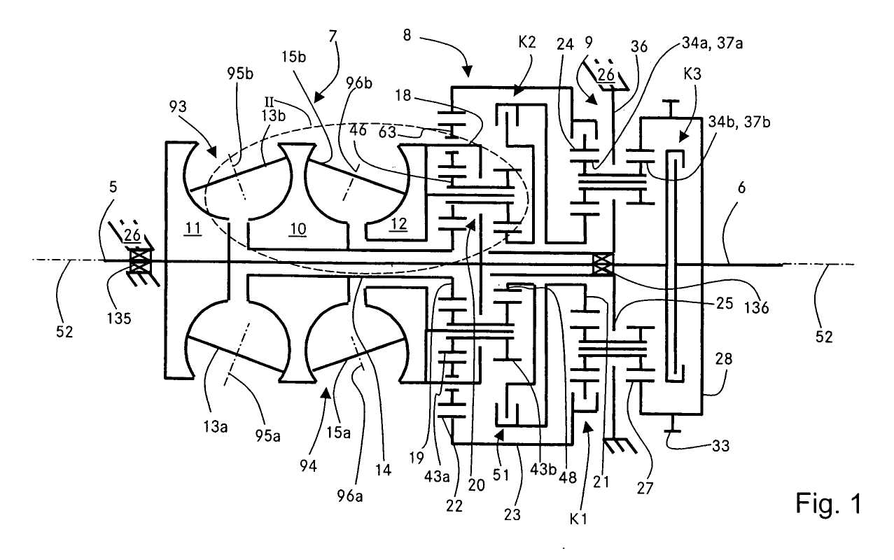

FIG. 1 shows a diagrammatical axial section through a continuously variable transmission which comprises a continuously variable toroidal variator 7, an epicyclic intermediate transmission 8 and an epicyclic output transmission 9.

The motor vehicle transmission is used in a drive train with a front-mounted engine and with a rear-axle drive. The motor vehicle transmission is thus arranged in the force flux between the front-mounted engine, not illustrated in any more detail, and a rear-axle differential transmission, by means of which rear drive shafts and therefore driving wheels are driven. The front-mounted engine is coupled to an input shaft 5 of the motor vehicle transmission and the rear-axle transmission is connected fixedly in terms of rotation by means of a drive shaft to an output shaft 6 of the motor vehicle transmission.

The input shaft 5 can be coupled frictionally to the output shaft 6 by means of a friction clutch K3 arranged at the rear end of the motor vehicle transmission, so that direct throughdrive from the engine to the rear-axle transmission can be-established. The input shaft 5 is mounted at its two end regions rotatably with respect to a nonrotating housing part 26 of the motor vehicle transmission by means of two antifriction bearings 135 and 136. In this instance, the two antifriction bearings 135 and 136 are designed as a fixed bearing/loose bearing pairing. The input shaft 5 is connected fixedly in terms of movement to an adjacent first central driving toroidal disk 11 of the toroidal variator 7 and, via the coaxial central input shaft 5, to a two-web planet carrier 18 of the intermediate transmission 8. This planet carrier 18 is connected fixedly in terms of rotation to the second central driving toroidal disk 12, arranged adjacent to the planet carrier 18, of the toroidal variator 7. The two driving toroidal disks 11 and 12 are thus connected in parallel or fixedly in terms of rotation with respect to one another. A hollow transmission shaft which is arranged coaxially with the input shaft 5 and through which the latter passes with play and which forms an intermediate shaft 14 is connected for rotation with the central toroidal disk 10. Concave toroidal driven surfaces are incorporated into this driven toroidal disk 10 on its opposite sides. The driven toroidal disk 10 is connected fixedly in terms of movement to an inner central wheel 19 of the intermediate transmission 8.

A driving toroidal disk 11 or 12 is in frictional contact with its associated driven surfaces of the toroidal disc 10 via two rollers 13a, 13b and 15a, 15b, Two rollers 13a, 13b and 15a, 15b are assigned respectively to one of two chambers 93, 94. The rollers 13a, 13b and 15a, 15b are both rotatable respectively about a specific axis of rotation 95a, 95b and 96a, 96b and pivotable about a pivot axis perpendicular to their specific axis of rotation 95a, 95b.

The inner central gear 19 of the intermediate transmission 8 has a drive connection 20 to an inner central wheel 21 as a first transmission member of the output transmission 9.

This drive connection 20 contains main planets 46 mounted on one web of the planet carrier 18 of the intermediate transmission 8 and having planetary gear rims 43a, 43b which are arranged on both sides of a radial drive web of the planet carrier 18 and of which one gear rim 43a meshes with the inner central gear 19 connected to the concentric intermediate shaft 14 and the other gear rim 43b meshes with a second inner central gear 48 which is arranged axially on the other side of the radial drive web and which finally, in turn, has a drive connection 51, containing an engageable and disengageable clutch K2, to the inner central gear 21 forming the first transmission member of the output transmission 9.

The gear rim 43a of the main planetary gear 46 which meshes with the one inner central gear 19 of the intermediate transmission 8 is additionally in meshing engagement with a secondary planetary gear 63 which is mounted on the second web of the planet carrier 18 and which, in turn, meshes with an outer central gear ring 22 which is connected fixedly in terms of rotation via a pot-shaped drive connection 23 to one clutch half of an engageable and disengageable friction clutch K1. A second clutch half of this friction clutch K1 is connected fixedly in terms of rotation to an outer central wheel 24 forming a second transmission gear ring of the output transmission 9.

The output transmission 9 has a third transmission member in the form of a planet carrier 25 which is connected fixedly in terms of rotation by means of a radial supporting web 36 to the non-rotating housing part 26 of the motor vehicle transmission and which supports planetary gears 34a, 34b with two gear rims 37a, 37b having the same number of teeth, which are arranged on opposite sides of the supporting web 36 and of which one gear rim 37a adjacent to the intermediate transmission 8 meshes both with the central gear wheel 21 and with the outer gear ring 24.

The output transmission 9 has a fourth transmission member in the form of a second outer central gear ring 27 which meshes with the gear rim 37b of the planetary gears 34b and which has a drive connection 28 to the output shaft 6.

A parking lock wheel 33 is arranged concentrically and fixedly in terms of movement at the outer circumference of the outer gear ring 27.

In the lower driving range, in forward drive the clutch K1 is engaged and the clutch K2 disengaged, so that the power is split at the intermediate transmission 8, a first part of the power flowing to the output shaft 6 and a second part of the power flowing via the toroidal variator 7 into the drive shaft 5.

In the upper driving range for forward drive, the clutch K1 is disengaged and the clutch K2 engaged, so that the power is combined at the intermediate transmission 8, a first part of the power flowing directly from the drive shaft 5 and a second part of the power flowing via the toroidal variator 7.

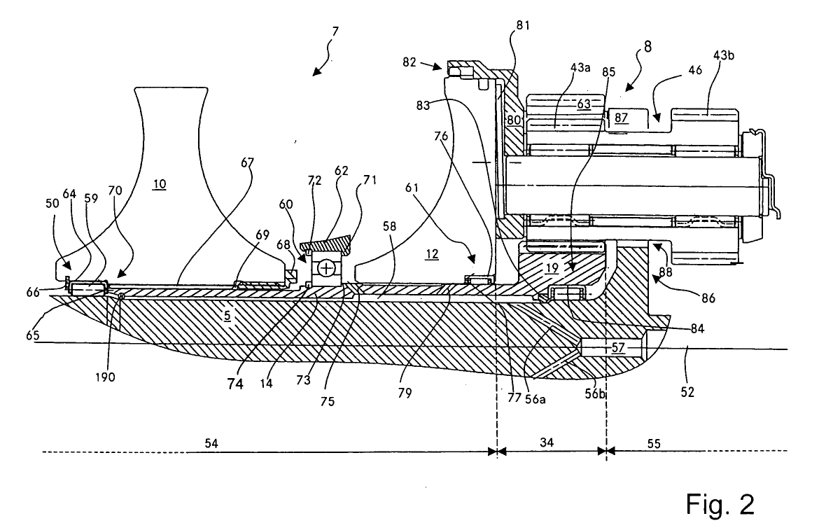

FIG. 2 is a detailed sectional illustration of a detail II of the transmission diagram from FIG. 1, although the rollers 13b, 15b from FIG. 1 are not illustrated.

The input shaft 5 has a first axial region 54 in which the toroidal variator 7 and the driving and driven toroidal disks 10, 11, 12 are also located. This first axial region 54 is designed as a solid shaft, with the result that its diameter is very small. This first axial region 54 has adjoining it a second axial region 34 in which a first gear set plane of the intermediate transmission 8 is also located, said first gear set plane comprising, inter alia,

the inner central gear 19,

the gear rim 43a and

the secondary planetary gear 63.

Two oil ducts 56a, 56b are drilled obliquely into the solid shaft in the second axial region 34. These oil ducts 56a, 56b extend, on the one hand, to an annular space 58 and, on the other hand, to a central bore 57 of the input shaft 5, said central bore lying essentially in a third axial region 55. The two oil ducts 56a, 56b thus provide for a flow connection between the central bore 57 which is under oil pressure and the annular space 58 which is located essentially in the first axial region 54. While the radially inner wall of the annular space 58 is formed by the input shaft 5, the radially outer boundary of the annular space 58 is formed by the concentric intermediate shaft 14 designed as a hollow shaft. Orifices for the release of lubricating oil from the annular space 58 are disposed at bearing points which are designed as the following non-friction bearings:
a) a first needle bearing 50 for the rotatable support of the driven toroidal disk 10 with respect to the input shaft 5,
b) a single-row grooved ball bearing 60 for the axial and radial mounting of the intermediate shaft 14 with respect to a housing part 62 of the motor vehicle transmission,
c) a second needle bearing 61 for the rotatable support of the second central driving toroidal disk 12 with respect to the intermediate shaft 14, and
d) a third needle bearing 85 for the radial support of the central gear 19 with respect to the input shaft 5 in the second region 34.

a) to c) are explained in more detail below.

a) The first needle bearing 50 comprises rolling bodies which are arranged within a cage 64 and roll on the input shaft 5 in a region in which the latter is a solid shaft. The cage 64 is inserted into a central bore of the driven toroidal disk 10 and bears axially, on one side, against an end face 65 of one end 70 of the intermediate shaft 14. The cage 64 bears axially, on the other side, against an axial securing ring 66 which is inserted into an inner slot at one axial end of the driven toroidal disk 10. At the other axial end of the driven toroidal disk 10, the latter is screwed to an externally threaded sleeve 68, the radially outward-projecting end collar of which bears axially against an end face of the driven toroidal disk 10. Axially between the first needle bearing 50 and the externally threaded sleeve 68, the driven toroidal disk 10 is connected fixedly in terms of rotation to the intermediate shaft 14 by means of spline toothing 67. In this instance, a slight axial play is permitted between the cage 64 and the end face 65 or between the externally threaded sleeve 68 and an external toothing 69, belonging to the spline toothing 67, of the input shaft 5.

The lubrication of the large needle bearing 50 takes place by means of lubricating oil which emerges, past a sealing ring 190 functioning as a virtual throttle, from the annular space 58 at the end 70 of the intermediate shaft 14.

b) The grooved ball bearing 60 has a bearing outer ring which is secured in the axial direction with respect to the housing part 62, on the one hand, on a step 71 and, on the other hand, on an axial securing ring 72 which is inserted into an inner slot of the housing part 62.

Similarly, a bearing inner ring of the grooved ball bearing 60 is secured in the axial direction with respect to the intermediate shaft 14, on the one hand, on a shoulder 73 and, on the other hand, on an axial securing ring 74 which is inserted into a circumferential slot of the intermediate shaft 14.

The lubrication of the grooved ball bearing 60 takes place by means of lubricating oil which emerges from the annular space 58 through an oblique bore 75 in the intermediate shaft 14. This bore 75 is arranged axially next to the grooved ball bearing 60 and is directed toward the rolling bodies of the latter.

c) The second needle bearing 61 comprises rolling bodies which are arranged within a cage 76 and roll on the intermediate shaft 14. The cage 76 is pressed into a central bore of the driving toroidal disk 12 and bears axially against an end face 77 of a bore bottom of this central bore.

An oblique bore 79, which supplies the second needle bearing 61 with lubricating oil, is drilled into the intermediate shaft 14 radially within the driving toroidal disk 12 and axially next to the second needle bearing 61.

The driving toroidal disk 12 is fixed in terms of rotation and axially prestressed with respect to a planet carrier bolt receptacle 80 of the planet carrier 18 by means of an axial toothing 82 and a cup spring 81.

The annular space 58 is sealed off, on its side facing the intermediate transmission 8, by means of a sealing ring 83 which is inserted into a concentric bore of the central gear 19, which is formed integrally with the intermediate shaft 14 and which functions as a virtual throttle, in that the sealing ring 83 allows a defined leakage. The sealing ring 83 is secured by means of a cage 84 of the third needle bearing 85. The sealing ring 83 bears with its inside against the input shaft 5 axially next to the two oil ducts 56a, 56b and allows the defined leakage throughflow to the supply of lubricant to the third needle bearing 85, while maintaining a lubricant pressure in the annular space 58.

A planet carrier arm 86 extends radially outward, axially next to the central gear 19, in the third region 55. This planet carrier arm 86 has webs 87 which extend outward in a radiating manner and which are interrupted circumferentially by recesses 88. The main planets 46 pass through these recesses 88, so that the gear rims 43a, 43b are adjacent to the planet carrier arm 86 on both sides.

Reference is made, as regards further details, to the publication DE 102 06 200.

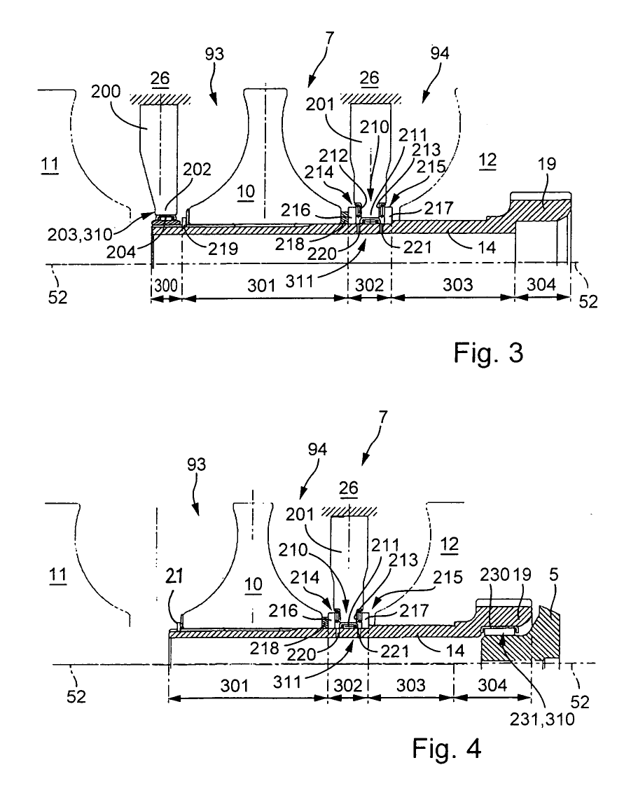

According to FIG. 3, the intermediate shaft 14 is supported via the bearing supports 200, 201. The bearing supports 200, 201 project into the chambers 93, 94 so as to be offset in the circumferential direction with respect to the rollers 13, 15.

The bearing support 200 is tied radially externally to the housing 26 and radially internally has a cylindrical surface area 202 in which a needle bearing 203 is received. The needle bearing 203 has needles which are held in a cage and roll radially externally on the surface area 202. The needles roll radially internally with respect to a hollow-cylindrical bearing ring 204 which is supported with respect to the intermediate shaft 14 in an axial end region of the latter.

In the other chamber 94 is arranged, radially internally with respect to the bearing support 201, a needle bearing 210 which radially externally rolls on a cylindrical surface area 211 of the bearing support 201 and radially internally rolls directly on an outer surface area of the intermediate shaft. In the cross section illustrated in FIG. 3, the surface area 211 is formed by a base leg of a U-shaped profile. The side legs 212, 213, which form radially oriented annular surfaces, constitute running surfaces of axial bearings 214, 215 each acting respectively on one side. The axial bearings 214, 215 are preferably axial cylindrical roller bearings which roll on the side legs 212, 213 on the sides facing the bearing support 201. On the side facing away from the bearing support 201, the rolling bodies of the axial bearings 214, 215 roll with respect to running surfaces of bearing disks 216, 217, said running surfaces lying in a radial plane. The bearing disks 216, 217 are supported radially internally with respect to the intermediate shaft 14. The bearing ring 217 is supported in the load direction of the axial bearing 215 on a shoulder of the intermediate shaft 14. For supporting in the opposite direction, a spacer disk 218 is interposed between the bearing disk 216 and the driven toroidal disk 10. The axial position of the bearing units 210, 214, 215, of the bearing rings 216, 217 and of the spacer ring 218 are secured via the position of the driven toroidal disk 10 which, for example according to FIG. 3, is fixed via a securing ring 219 engaging the intermediate shaft 14 between the driven toroidal disk 10 and the bearing support 200. Preferably, between the intermediate shaft 14, the bearing support 201 and the bearing rings 216, 217, at least one lubricating space is formed, in which the abovementioned bearing units are arranged and which is supplied via lubricating bores 220, 221 extending radially through the intermediate shaft 14. In particular, the intermediate shaft 14 has an approximately constant outside diameter in the axial region of the bearing support 201, of the bearing units 210, 214, 215, of the driven toroidal disk 10, of the securing ring 119 and of the bearing ring 204, a spline toothing being provided, at least in the region of the driven toroidal disk 10, for the transfer of a torque between the intermediate shaft 14 and the driven toroidal disk 10.

With a configuration which otherwise corresponds essentially to the embodiment according to FIG. 3, according to the exemplary embodiment illustrated in FIG. 4 the bearing support 200, the needle bearing 203 and the bearing ring 204 are dispensed with, and therefore the intermediate shaft 14 can have a shortened design in the part region assigned. Instead, according to FIG. 4, a loose bearing is provided between the intermediate shaft 14 and a further transmission element, here the input shaft 5. For this purpose, the intermediate shaft 14 has, in the part region projecting from the variator 7, an axial cylindrical recess 230 which is preferably arranged radially internally in the inner central gear 19. The recess 230 has inserted into it a needle bearing 231 which rolls radially externally on the recess 230. The needle bearing 231 rolls radially internally on a suitable cylindrical surface area of the input shaft 5.

Alternatively, it is possible to the intermediate shaft 14 support by means of a central fixed bearing in the form of the bearing units 214, 215, 210 and two loose bearings 203, 231 arranged on opposite axial sides of the fixed bearing.

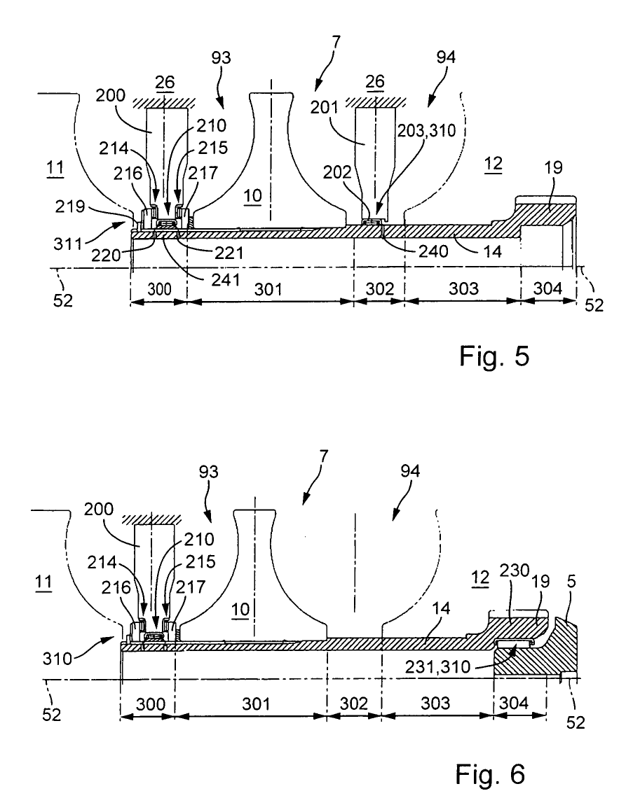

With a configuration otherwise corresponding to the exemplary embodiment according to FIG. 3, for the exemplary embodiment according to FIG. 5 the fixed bearing formed by the bearing units 210, 214, 215 is assigned to the bearing support 200, while the needle bearing 203 is assigned to the bearing support 201. In this instance, the driven toroidal disk 10 is supported axially on one side with respect to a shoulder of the intermediate shaft 14. In this instance, the fixed bearing is secured axially via a securing ring 219 assigned to the latter. The bearing support 201 has, in the region of the surface area 202, a step for predetermining an axial end position or a guide of the needle bearing 203. In this instance, an additional lubricating bore 240 for supplying the needle bearing 203 is provided. Furthermore, the needle bearing 210 assigned to the fixed bearing does not roll directly on the intermediate shaft 14, but, instead, with respect to a bearing ring 241 mounted on the intermediate shaft 14. On the other hand, for the loose bearing formed by the needle bearing 203, the bearing ring 204 is dispensed with, so that said loose bearing rolls directly on the intermediate shaft 14.

Contrary to FIG. 5, with an otherwise corresponding configuration, in the exemplary embodiment according to FIG. 6 the bearing support 201 and the needle bearing 203 are dispensed with, while, in that end region of the intermediate shaft 14 which lies opposite the fixed bearing formed by the bearing units 210, 214, 215, the intermediate shaft 14 is supported with respect to the transmission input shaft 5 by means of a needle bearing 231 according to FIG. 4. Thus, whereas, according to FIG. 4, an introduction of forces via the driven toroidal disk 10 takes place axially outside the bearing points, according to FIG. 6 the intermediate shaft 14 is radially supported respectively in its axial end regions, so that the forces acting on the intermediate shaft 14 are advantageously introduced into the intermediate shaft 14 between the bearings.

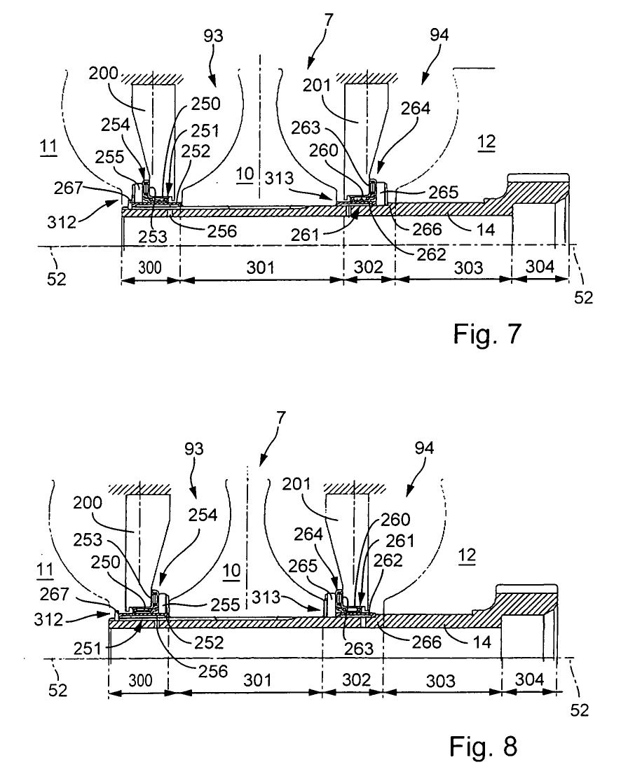

According to the exemplary embodiment illustrated in FIG. 7, the bearing support 200 has an L-shaped cross section in the radially internal end region. The base leg of the L forms a cylindrical inner surface 250 which receives a needle bearing 251. The needle bearing 251 rolls radially externally on the inner surface 250 and radially internally on a liner 252 which is supported radially internally on the intermediate shaft 14. The side leg of the L forms an annular running surface 253, on which is supported in the axial direction an axial bearing 254 which acts on one side and which is designed as an axial cylindrical roller bearing in the exemplary embodiment illustrated in FIG. 7. The rolling bodies of the axial bearing 254 roll on the running surface 253 on the side facing the bearing support 200, while rolling on the axially opposite side takes place on a bearing ring 255. In particular, the bearing units 251, 254 are to be supplied with a lubricant via a radial bore 256 of the intermediate shaft 14.

The bearing support 201 has an L-shaped end region in the radially inner end region. The base leg of the L forms a cylindrical inner surface 260 in which a needle bearing 261 is received. The needle bearing 261 rolls radially externally on the inner surface 260. The needle bearing 261 rolls radially internally on a liner 262 which is supported in the radial direction with respect to the intermediate shaft 14. The side leg of the L forms a running surface 263 arranged in a radial plane. On the running surface 263 is supported an axial bearing 264 which is designed as an axial cylindrical roller bearing in the exemplary embodiment illustrated. The axial bearing 264 rolls with its rolling bodies, on the one hand, on the running surface 263 and, on the other hand, with respect to a bearing ring 265 which is supported radially internally with respect to the intermediate shaft 14.

The bearing ring 265, the liner 262, the driven toroidal disk 10 and the liner 252 are supported with respect to a shoulder 266 of the intermediate shaft 14 in said order via a common securing ring 267. An axial support of the bearing ring 255 likewise takes place via the securing ring 267. According to the exemplary embodiment illustrated in FIG. 7, the base legs of the L-shaped end regions of the bearing supports 200, 201 face one another.

Contrary to this, with a configuration otherwise corresponding to FIG. 7, according to the exemplary embodiment illustrated in FIG. 8 the base legs of the L-shaped cross sections of the bearing supports 200, 201 are arranged so as to face away from one another. In this instance, the bearing rings 255 and 265 are supported on the driven toroidal disk 10 on the side facing away from the axial bearings 254, 264. The liner 262, the driven toroidal disk 10 and the liner 252 are supported on the step 266 in this order via the securing ring 267.

The embodiments described are merely exemplary configurations. A combination of the features described for different embodiments is likewise possible. Further features, in particular features not described, of the device parts belonging to the invention, in particular their geometry, their operative connections and their arrangement in relation to one another, may be gathered from the drawing.

The transmission shaft according to the invention is, in particular, a shaft which carries the driving or driven toroidal disks, which is drive-connected to these or which is produced in one piece with these.

The invention, in its various embodiments, is used irrespective of whether the inner toroidal disks are driven toroidal disks according to the embodiments illustrated or else driving toroidal disks. On the side facing away from the rollers in the force flux, the force flux runs, in particular, from the inner toroidal disks via a transmission shaft connected fixedly in terms of rotation and/or via a transmission stage, a gearwheel of the transmission stage being connected fixedly in terms of rotation to the inner toroidal disks, cf., for example, EP 1 186 798 A2, DE 199 48 756 A1.

According to FIG. 3, the intermediate shaft 14 has, adjoining one another in the following axial order, a part region 300 in which the needle bearing 203 designed as a loose bearing 310 is arranged, a part region 301 which carries the driven toroidal disk 10, a part region 302 in which the fixed bearing 311 designed with the axial bearings 214, 215 and with a needle bearing is arranged, a part region 303 which is surrounded radially by the driving toroidal disk 12, and a part region 304 in which the central wheel 19 is formed.

According to FIG. 4, the intermediate shaft 14 has, adjoining one another in the following axial order, a part region 301 which carries the driven toroidal disk 10, a part region 302 in which the fixed bearing 311 designed with the axial bearings 214, 215 and with a needle bearing is arranged, a part region 303 which is surrounded radially by the driving toroidal disk 12, and a part region 304 in which the central wheel 19 and, together with the needle bearing 231, a loose bearing 310 between the intermediate shaft 14 and input shaft 5 are formed.

According to FIG. 5, the intermediate shaft 14 has, adjoining one another in the following axial order, a part region 300 in which the fixed bearing 311 designed with the axial bearings 214, 215 and with a needle bearing is arranged, a part region 301 which carries the driven toroidal disk 10, a part region 302 in which the needle bearing 203 in the form of a loose bearing 310 is arranged, a part region 303 which is surrounded radially by the driving toroidal disk 12, and a part region 304 in which the central gear 19 is formed.

According to FIG. 6, the intermediate shaft 14 has, adjoining one another in the following axial order, a part region 300 in which the fixed bearing 311 designed with the axial bearings 214, 215 and with a needle bearing is arranged, a part region 301 which carries the driven toroidal disk 10, a part region 302 without bearings, a part region 303 which is surrounded radially by the driving toroidal disk 12, and a part region 304 in which the central gear 19 and, together with the needle bearing 231, a loose bearing 310 between the intermediate shaft 14 and input shaft 5 are formed.

According to FIG. 7, the intermediate shaft 14 has, adjoining one another in the following axial order, a part region 300 in which the one-sided bearing unit 312 designed with the axial bearing 254 and with a needle bearing 251 is arranged, a part region 301 which carries the driven toroidal disk 10, a part region 302 in which the one-sided bearing unit 313 designed with the axial bearing 264 and with a needle bearing 261 is arranged, a part region 303 which is surrounded radially by the driving toroidal disk 12, and a part region 304 in which the central gear 19 is formed. The one-sided bearing units 312, 313 are installed in an X-arrangement in pairs, if appropriate under prestress.

With an arrangement otherwise corresponding to FIG. 7, according to FIG. 8, the one-sided bearing units 312, 313 are installed in an O-arrangement in pairs, if appropriate under prestress.

At least one cup spring for centering and pre-stressing the mounting is provided between the securing ring 219 and driven toroidal disk 10 in FIG. 3 and FIG. 4, between the bearing disk 216 and spring ring 219 in FIG. 5 and FIG. 6, between the bearing ring 255 and spring ring 267 and between the bearing disk 265 and step 266 in FIG. 7 and between the bearing ring 255 and driven toroidal disk 10 and between the bearing ring 255 and driven toroidal disk 10 in FIG. 8. This design is not mandatory, but simplifies assembly.

What is claimed is:

1. A continuously variable transmission with a toroidal variator (7) having a housing (26) including outer and central toroidal diks (11, 12, 10) defining therebetween first and second chambers (93, 94), motion transmitting rollers 13a, 13b, 15a, 15b disposed in the two chambers in contact with the toroidal disks for the transfer of a drive torque between the outer toroidal disks (11, 12) which are drive-connected to one another and the inner toroidal disks (10) also drive-connected to one another in the toroidal variator (7) via the rollers (13, 15), a transmission shaft (14) rotatably supported in the housing (26) of the transmission and at least partially extending radially internally through the toroidal variator (7), said transmission shaft (14) being supported by said housing (26) solely via
a first bearing support structure (200), which is fixed with respect to the housing (26) and which passes radially through the toroidal variator (7) in the region of the first chamber (93), a first bearing unit disposed between the first bearing support (200) and the transmission shaft (14), and
a second bearing support (201), which is fixed with respect to the housing (26) and which passes radially through the toroidal variator (7) in the second chamber (94) in the radial direction, and a second bearing unit disposed between the second bearing support (201) and the transmission shaft (14).

2. The continuously variable transmission as claimed in claim 1, wherein the transmission shaft (14) is supported with respect to the housing (26) via a bearing unit which acts between the first bearing support structure (200, 201) and the transmission shaft (14) and which is designed as a fixed bearing (311) and via a bearing unit disposed between the second bearing support (201, 200) and the transmission shaft (14) and which is in the form of a loose bearing (310).

3. The continuously variable transmission as claimed in claim 1, wherein the transmission shaft (14) is supported on the bearing support structures (200, 201) by means of a first bearing unit (312) acting axially on one side and a second bearing unit (313) acting axially on opposite sides of the respective bearing units (312, 313).

4. The continuously variable transmission as claimed in claim 1, wherein, in addition to the support via the first bearing support (200, 201) fixed with respect to the housing, a bearing unit (231) is provided between the transmission shaft (14) and another rotating transmission element (input shaft 5).

5. The continuously variable transmission as claimed in claim 1, wherein a bearing unit in the form of a fixed bearing (311) is a four-point bearing.

6. The continuously variable transmission as claimed in claim 1, wherein a bearing unit in the form of a fixed bearing (311) is a combination of a needle bearing (210) with two bearings (214, 215), axially engaging opposite sides of the bearing support structure.

7. The continuously variable transmission as claimed in claim 1, wherein the bearing unit (203; 231) in the form of a loose bearing (310) is a needle bearing.

8. The continuously variable transmission as claimed in claim 1, wherein the transmission include an input shaft (5) and a hollow outer shaft (14) and the transmission shaft (14) is connected fixedly in terms of rotation to the central toroidal disks (10).

9. The continuously variable transmission as claimed in claim 8, wherein the input shaft 5 extends through the hollow transmission shaft (14).

10. The continuously variable transmission as claimed in claim 8, wherein an end region of the hollow transmission shaft (14) is arranged within the toroidal variator (7), while the opposite end region of the hollow transmission shaft (14) projects from the toroidal variator (7) for the transfer of a torque acting upon the toroidal variator (7) at a variable speed relating to the input shaft (5).

11. A continuously variable transmission with a toroidal variator (7) having a housing and first and second chambers (93, 94), motion transmitting rollers (13a, 13b, 15a, 15b) disposed in said chambers in contact with said disks for the transfer of a drive torque between the outer toroidal disks (11, 12) which are drive-connected to one another and the inner toroidal disks (10) which are drive-connected to each other in the toroidal variator (7) via said rollers (13a, 13b, 15a, 15b), a transmission shaft (14) mounted with respect to the housing (26) of the transmission, said housing including bearing support structures extending radially into the toroidal variator (7), for supporting the transmission shaft (14) with respect to the housing (26) via a bearing support (200; 201) which is fixed with respect to the housing structure that extends into the toroidal variator (7) in the region of a chamber (93; 94) in the radial direction, there being arranged between the bearing support (200; 201) and the transmission shaft (14) a fixed bearing (311) which includes a needle bearing (210) for the accommodation of radial forces and at least one axial bearing (214, 215) for the accommodation of axial forces.

12. A continuously variable transmission with a toroidal variator (7) having a housing and first and second chambers (93, 94), motion transmitting rollers (13a, 13b, 15a, 15b) disposed in said chambers in contact with said disks for the transfer of a drive torque between the outer toroidal disks (11, 12) which are drive-connected to one another and inner toroidal disks (10) which are drive-connected to each other in the toroidal variator (7) via said rollers (13a, 13b, 15a, 15b), a transmission shaft (14) mounted with respect to the housing (26) of the transmission, said housing including bearing support structures extending radially into the toroidal variator (7) in the region of the first chamber (93, 94), and a loose bearing (310) arranged between the bearing support (200, 201) and the transmission shaft (14).
